(19) United States
(12) Patent Application Publication
(10) Pub. No.: US 2014/0306556 A1
(43) Pub. Date: Oct. 16, 2014

(54) HOUSING AND VIBRATING DEVICE INCLUDING THE SAME

(71) Applicant: SAMSUNG ELECTRO-MECHANICS CO., LTD., Suwon (KR)

(72) Inventors: Yong Tae KIM, Suwon (KR); Jung Taek HONG, Suwon (KR); Kyung Su PARK, Suwon (KR)

(73) Assignee: SAMSUNG ELECTRO-MECHANICS CO., LTD., Suwon (KR)

(21) Appl. No.: 13/943,209

(22) Filed: Jul. 16, 2013

(30) Foreign Application Priority Data
Apr. 12, 2013 (KR) 10-2013-0040594

(51) Int. Cl. H02K 33/00

(52) U.S. Cl. CPC H02K 33/00
USPC 310/25

(57) ABSTRACT

There is provided a housing, including: a case formed in a longitudinal direction, having an opening on one side, and having an internal space; and a bracket coupled to the opening on the one side of the case; wherein the case has a protrusion formed at the opening and protruding in the longitudinal direction of the case.

### CROSS-REFERENCE TO RELATED APPLICATIONS

This application claims the priority of Korean Patent Application No. 10-2013-0040594 filed on Apr. 12, 2013, in the Korean Intellectual Property Office, the disclosure of which is incorporated herein by reference.

### BACKGROUND OF THE INVENTION

1. Field of the Invention

The present invention relates to a housing and a vibrating device including the same.

2. Description of the Related Art

A vibrating device, a component converting electrical energy into mechanical vibrations through the generation of electromagnetic force, is mounted in an electronic device such as a mobile phone to be used for silently notifying a user of an incoming call.

Further, as the market for electronic devices such as mobile phones rapidly expands, various functions are being added to electronic devices. Accordingly, as demand for smaller and more highly functional electronic devices increases, a new vibrating device capable of overcoming shortcomings of existing products and having markedly improved quality is also required.

In recent years, as the release of mobile phones having large liquid crystal display (LCD) screens has rapidly increased, a touchscreen scheme has been adopted for use therewith, such that a vibrating device has been used in order to generate vibrations when a touch is applied to such an LCD screen.

Such a vibrating device, used in electronic devices having touchscreens, needs to have a longer operational lifespan, since it is used much more than a vibrating device for notifying a user of an incoming call, and is required to have a faster response speed in accordance with the speed of a touch applied to a touchscreen.

To comply with the requirements for extended lifespans and response speeds, a linear vibrator is currently being used in electronic devices having touchscreens.

The linear vibrator generates vibrations, not through the rotation of a motor, but through electromagnetic force having a resonant frequency determined by using an elastic member installed in the vibrating device and a mass body connected to the elastic member.

Such a linear vibrating device is required to be reduced in size as electronic devices are themselves reduced in size. However, such a linear vibrator has essential components provided therein which may not be able to be reduced in size. Accordingly, a linear vibrator having a new structure which allows for effective component arrangements is required.

That is, there is a concern that a coil may be short-circuited if components in a linear vibrator and the coil make contact with one another during operating of the linear vibrator.

Moreover, the linear vibrator not only needs to have fast response speeds, but also must be able to stop as soon as vibrations should cease. However, existing linear vibrators fail to immediately stop.

### SUMMARY OF THE INVENTION

An aspect of the present invention provides a vibrating device removed in size through improving component arrangements therein.

An aspect of the present invention also provides a vibrating device capable of stopping as soon as a vibration condition is over.

An aspect of the present invention also provides a housing in which contact between components and a coil is prevented while operating, and a vibrating device including the same.

According to an aspect of the present invention, there is provided a housing, including: a case formed in a longitudinal direction, having an opening on one side, and having an internal space; and a bracket coupled to the opening on the one side of the case; wherein the case has a protrusion formed at the opening and protruding in the longitudinal direction of the case.

The case may have a cylindrical shape, and parts of external and internal surfaces of the case may have a flat shape.

The flat shape may be formed in the longitudinal direction from one end to the other end of the case.

The protrusion may be formed on flat parts of the external and internal surfaces of the case and extend therefrom.

The case may have a half-cylindrical shape, and one surface of the case may have a flat shape.

The protrusion may be formed on the one surface of the half-cylindrical case having the flat shape, and extend therefrom.

A width of the protrusion may be smaller than that of the one surface of the case.

According to another aspect of the present invention, there is provided a vibrating device, including: the housing as described above; a shaft provided in the internal space; a frame into which the shaft is inserted; a vibrating part coupled to an outer peripheral surface of the frame and having a magnetic part; a bearing member supporting the frame so that the shaft and the frame are spaced apart from each other by a predetermined distance; an elastic member provided at both ends of the vibrating part; and a coil provided in the internal space and interacting with the magnetic part so as to vibrate the vibrating part.

The coil may be mounted on an inner surface of the case.

The protrusion may have a printed circuit board mounted on its inner surface, and one side of the printed circuit board may be disposed adjacently to one side of the coil.

A lead-out line of the coil may be electrically connected to the printed circuit board.

According to another aspect of the present invention, there is provided a housing, including: a case formed in a longitudinal direction, having an opening on one side, and having an internal space; and a bracket coupled to the opening on the one side of the case; wherein the case has a hole penetrating through one surface thereof.

According to another aspect of the present invention, there is provided a vibrating device, including the housing as described above, and a printed circuit board mounted on an outer surface of the case so as to cover at least part of the hole.

According to another aspect of the present invention, there is provided a vibrating device, including: the housing as described above; a shaft provided in the internal space; a frame into which the shaft is inserted; a vibrating part coupled to an outer peripheral surface of the frame and having a magnetic part; a bearing member supporting the frame so that the shaft and the frame are spaced apart from each other by a predetermined distance; an elastic member provided at both ends of the vibrating part; and a coil provided in the internal space and interacting with the magnetic part so as to vibrate the vibrating part.

A printed circuit board may be mounted on an outer surface of the case so as to cover at least part of the hole, and a lead-out line of the coil may pass through the hole so as to be electrically connected to the printed circuit board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of an assembled vibrating device according to an embodiment of the present invention;

FIGS. 2A to 2C are cross-sectional views of variant examples of the fitting part and guide part of the housing provided in the vibrating device according to the embodiment of the present invention;

FIG. 3 is a half cross-sectional, exploded perspective view of the vibrating device according to the embodiment of the present invention; FIGS. 4A to 4C are perspective and front views of the housing of the vibrating device according to the embodiment of the present invention;

FIG. 5 is a perspective view of the vibrating device according to the embodiment in which a case and a printed circuit board are coupled to each other;

FIG. 6 is a perspective view of the vibrating device according to the embodiment in which the case, a bracket and the printed circuit board are coupled to one another;

FIGS. 7A to 7C are perspective and front views of the housing of the vibrating device according to another embodiment of the present invention;

FIG. 8 is a perspective view of the vibrating device according to the another embodiment in which a case and a printed circuit board are coupled to each other; FIG. 9 is a perspective view of the vibrating device according to the another embodiment in which the case, a bracket and the printed circuit board are coupled to one another; and

FIGS. 10A to 10C are perspective and front views of a housing of a vibrating device according to another embodiment of the present invention.

### DETAILED DESCRIPTION OF THE INVENTION

Embodiments of the present invention will now be described in detail with reference to the accompanying drawings. The embodiments of the present invention may be modified in many different ways and the scope of the invention should not be limited to the embodiments set forth herein. Rather, these embodiments are set forth to provide thorough and complete understanding of the present invention, and will fully convey the concept of the invention to those skilled in the art. In the accompanying drawings, shapes and dimensions of elements may be exaggerated for clarity.

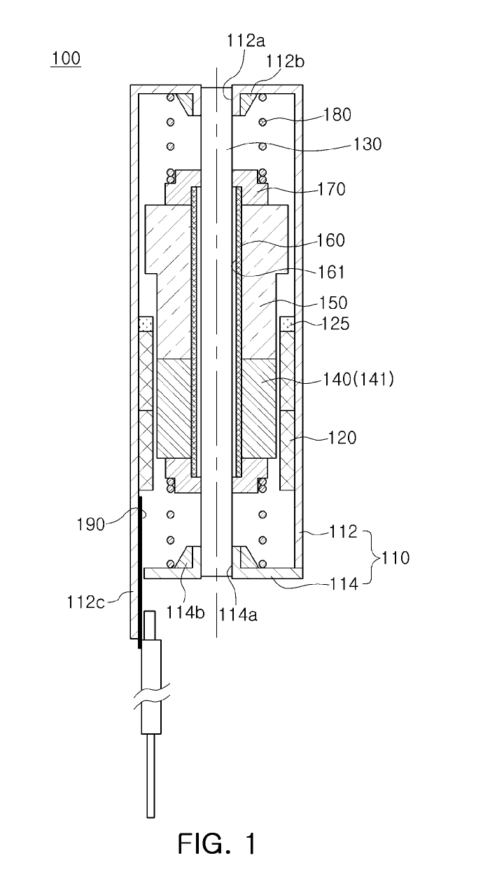

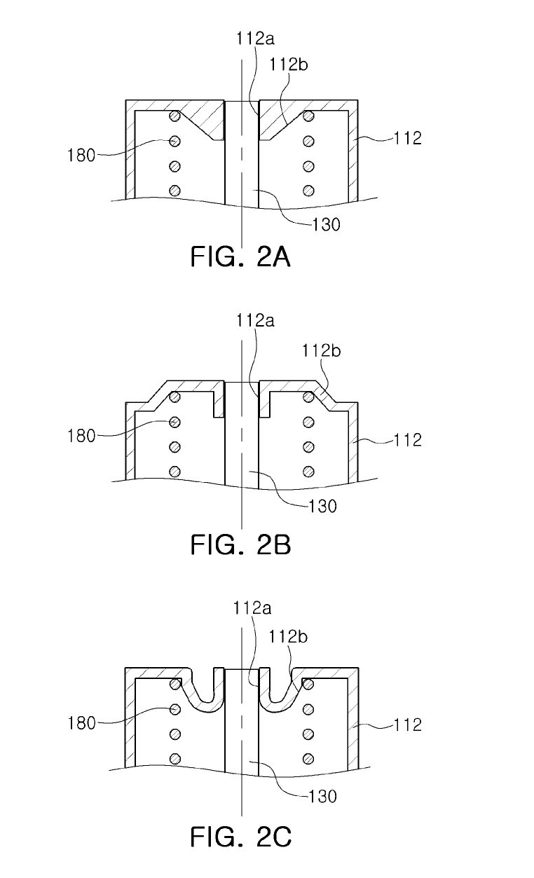

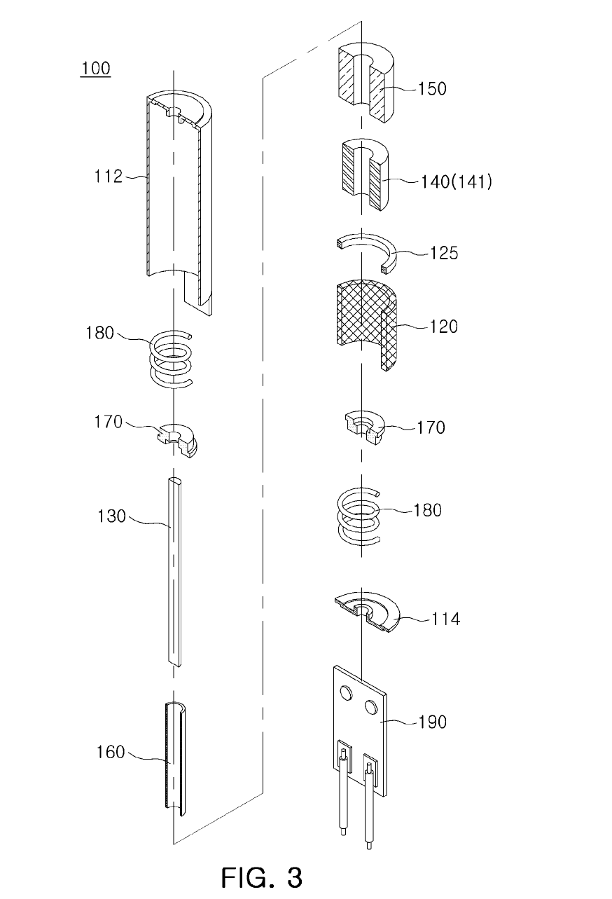

FIG. 1 is a cross-sectional view of an assembled vibrating device according to an embodiment of the present invention; FIGS. 2A to 2C are cross-sectional views of variant examples of the fitting part and guide part of the housing provided in the vibrating device according to the embodiment of the present invention; and FIG. 3 is a half cross-sectional, exploded perspective view of the vibrating device according to the embodiment of the present invention.

Referring to FIGS. 1 through 3, the vibrating device 100 according to the embodiment of the present invention may include, for example, a housing 110, a coil 120, a shaft 130, a magnetic field part 140, amass body 150, a frame 160, bearing members 170, and an elastic member 180. As appreciated by those skilled in the art, the above configuration is merely an example, and any element may be removed from or other elements may be added to the configuration.

First of all, directions herein are defined as follows: A shaft direction (longitudinal direction) refers to the vertical direction in FIG. 1, i.e., the direction from one end to the other end of the housing 110 and vice versa. A radial direction (width direction) refers to the direction from the left to the right and vice versa in FIG. 1.

Further, a circumferential direction refers to a direction rotating along an inner or outer surface of a member on the longitudinal direction shaft.

The housing has an internal space and forms an outer shape of the vibrating device 100.

The housing 110 may include a case 112, one side of which is opened and having an internal space, and a bracket 114 disposed on the one side for enclosure thereof.

The case 112 may be made of a magnetic material so that it forms a magnetic closed-circuit and prevents magnetic leakage. However, the material for the case 112 is not limited a magnetic material but may be formed of other materials.

The case 112 may be formed by performing a plastic working (e.g., a press process) on a steel sheet, and may be formed also by a die-casting process.

Further, the housing 110 forming the internal space may have fitting parts 112a and 114a at ends of its inner surface. The fitting parts 112a and 114a may have a groove or hole shape, and each of the ends of the shaft 130 is fitted into the respective fitting parts 112a and 114a.

As shown in FIG. 1, the fitting parts 112a and 114a may protrude in the shaft direction at the openings of the ends of the inner surface of the housing 110.

Turning to FIGS. 2A to 2C, the fitting parts 112a and 114a may have the cross-sectional area to be smaller toward the center of the housing 110. Therefore, the fitting parts 112a and 114a may be thicker as they are closer to the housing 110 (see FIG. 2A).

In addition, the fitting parts 112a and 114a may be bent toward the center of the housing 110 at the openings of the ends of the inner surface of the housing 110, and again bent toward the outer side of the housing 110 (see FIG. 2C).

Further, the housing 110 forming the internal space may have guide parts 112b and 114b at ends of its inner surface.

The guide part 112b that fixes the end of the elastic member 180 may be provided on the case 112, and the guide part 114b that fixes the end of the elastic member 180 may be provided on the bracket 114.

Specifically, the guide parts 112b and 114b may be fixedly attached on the outer peripheral surface of the fitting parts 112a and 114a, respectively, and on the respective ends of the inner surface of the housing 110.

The guide part 112b of the case 112 may be simply formed by injection and the like.

The bracket 114 may be formed of a metal material so as to be securely fixed to the case 112, and may be formed by a plastic working or die-casting, for example.

However, the present invention is not limited thereto but the bracket 114 may be formed of a synthetic resin and formed by injection. Here again, the guide part 114b that fixes the end of the elastic member 180 may be provided on the bracket 114.

The guide parts 112b and 114b may have a cylindrical shape having a hollow center, and the cross-sectional area thereof may vary in the shaft direction.

That is, the guides 112b and 114b may have the largest cross-sectional areas at the ends of the inner surface of the housing 110 on which the guides 112b and 114b are attached.

The ends of the elastic member 180 may be fitted at the largest cross-sectional areas so as to be fixed.

Although FIG. 1 shows that the guides 112b and 114b are formed separately from the fitting parts 112a and 114a, and the guides 112b and 114b are attached on the outer peripheral surface of the fitting parts 112a and 114a, respectively, and on the respective ends of the inner surfaces of the housing 110, the present invention is not limited thereto but the guide parts 112b and 114b and the fitting parts 112a and 114a may integrated as shown in FIG. 2A.

Further, as shown in FIG. 2B, the guide parts 112b and 114b may have inclined surfaces that are bent toward the outside of the housing 110 as they move into the inside in the radial direction, such that the ends of the elastic member 180 may be fixedly fitted.

Moreover, as shown in FIG. 2C, the guide parts 112b and 114b are formed so that they are bent toward the center of the housing 110 at the openings of the ends of the inner surface of the housing 110, and the fitting parts 112a and 114a may be formed so that the ends of the guide parts 112b and 114b are bent again toward the outside of the housing 110. Then, the ends of the elastic member 180 may be fitted into the guide parts 112b and 114b so as to be fixedly coupled. Such a shape may be formed by applying a reverse drawing.

Here, a damper (not shown) may be provided at at least one of the ends of the inner surface of the housing 110 forming the internal space or the ends of a vibrating part including the magnetic field part 140 and the mass body 150, to be described below.

That is, a member that absorbs impacts occurring if the vibrating part and the internal space of the housing 110 are contacted with each other when the vibrating part vibrates in the internal space in the width direction may be provided.

The coil 120 may be provided in the internal space of the housing 110.

As an example, the coil 120 may be installed on the inner peripheral surface of the case 112 along the circumferential direction. That is, the coil 120 may have a shape covering the inner peripheral surface (inner surface) of the case 112.

In addition, the coil 120 may have a cylindrical shape. A magnet 141 may vibrate inside the coil 120 in the shaft direction when the vibrating part including the magnetic field part 140 and the mass body 150 vibrates.

That is, the coil 120 serves to generate a driving force to vibrate the vibrating part by the electromagnetic interaction with the magnetic part 140 (the magnet).

In addition, the coil 120 needs to be connected to an external power in order to be powered.

To this end, the lead-out line of the coil 120 is connected to a printed circuit board 190 so as to supply the coil 120 with power.

The coil 120 may be disposed at one side in the shaft direction so that it is in the internal space of the housing 110.

That is, as will be described in detail, in an embodiment of the present invention, the magnetic part 140 including a magnet may be disposed at one side in the shaft direction.

The coil 120 may be disposed so that the interaction with the magnetic part 140 may be easily made.

In addition, a yoke 125 made of a magnetic material may be disposed at at least one of the ends of the coil 120.

In particular, the yoke 125 may be provides at one of the ends of the coil 120 which has a portion that overlaps with the magnet in the shaft direction.

The yoke 125, formed of a magnetic material, may serve as a vibration stopper that forms a magnetic force with the magnetic part 140 including a magnet when power supply to the coil 120 is stopped, so that it facilitate the stoppage of the vibrating part including the magnetic part 140 and the mass body 150.

That is, the residual vibration is minimized while the stop response speed of the vibrating device is maximized.

The shaft 130 extends in the internal space of the housing 110 in the shaft direction (i.e., vertical direction in FIG. 1) so that it may be mounted in the housing 110.

That is, the ends may be fitted into the fitting parts 112a and 114a provided in the housing 110.

The shaft 130 may serve to direct the vibration of the vibrating part in the vibrating device according to an embodiment of the present invention.

The magnetic part 140 may be provided on one side of in the internal space of the housing 110.

In this connection, as described above, the coil 120 also may be disposed on one side of the housing 110. Moreover, the mass body 150 may be connected to the other side of the magnetic part 140.

The magnetic part 140 generates a vibration driving force by the electromagnetic interaction between the magnet 141 including the magnetic part 140 and the coil 120 provided in the housing 110.

The magnet 141 has a cylindrical shape, one side is magnetized as an N pole and the other side is magnetized as a S pole in the shaft direction.

Here, a mechanism that generates the driving force by the magnet 141 is briefly descried.

Initially, once the coil 120 is powered, a driving force is generated by the interaction between the coil 120 and the magnet 141.

At this time, an AC current is applied to the coil 120, and, accordingly, the driving force generated by the coil 120 and the magnet 141 alternates in the shaft direction. Accordingly, the magnet 141 vibrates in the shaft direction.

The mass body 150 may be provided at the end of the magnetic part 140 including the magnet 141 (the opposite side to the one side in the direction that the magnetic part 140 is provided in the inner surface of the housing 110).

That is, the mass body 150 may be disposed at the one end of the magnetic part 140 so as to vibrate with the magnetic part 140.

In an embodiment of the present invention, the mass body 150 serves to increase the vibration when the driving force is generated by the interaction between the coil 120 and the driving magnet 141.

To this end, the mass body 150 may be formed of a material with a high specific gravity, e.g., non-magnetic, copper-based material such as brass or tungsten material.

Here, the coil 120 is provided between at least a part of the magnet 141 and the inner peripheral surface of the housing 110.

However, since the mass body 150 directly faces the inner peripheral surface of the housing 110, the diameter of the mass body 150 may be larger than the diameter of the magnet 141.

Here, the magnetic part 140 and the mass body 150 may be a vibrating part that vibrates with respect to the stator part.

Moreover, a frame 160 to be described may also be included in the vibrating part since it vibrates with the vibrating part while having the vibrating part at its outer surface.

The frame 160 may have the magnetic part 140 and the mass body 150 on its outer peripheral surface.

That is, the frame 160 may have the vibrating part integrally so as to make a linear vibrator easily assembled. The frame 160 may have a cylindrical shape. The frame 160 may be made of a magnetic or non-magnetic material.

The frame 160 may have the magnetic part 140 and the mass body 150 on the outer peripheral surface, and the inner peripheral surface of the frame 160 may face the outer peripheral surface of the shaft 130.

In this connection, the frame 160 may have a shaft hole 161 in the longitudinal direction (shaft direction) . Since the frame 160 does not have a direct contact with the shaft 130, the diameter of the shaft hole 161 may be larger than that of the shaft 130.

Bearing members 170 may be provided to the frame 160. The bearing members 170 may vibrate while having a direct contact with the outer surface of the shaft 110.

That is, the bearing members 170 may be slidable on the shaft 110. That is, the bearing members 170 may be moved in the shaft direction, i.e., vertical direction in FIG. 1, along the shaft 130 by the interaction between the magnet 141 and the coil 120.

Each of the bearing members 170 may be provided the respective ends of the frame 160, and support the frame 160 so that the frame 160 and the shaft 110 is maintained spaced apart from each other.

The inner peripheral surfaces of the bearing members 170 may have a circle shape so that it may slide on the outer surface of the shaft 160.

In addition, the outer surfaces of the bearing members 170 may be stepped so that the elastic member 180 to be described below is fixed.

Further, the bearing member 170 may configure, along with the magnetic part 140 and the mass body 150, a vibrator that vibrates with respect to a stator.

The elastic member 180 has one end fixed to ends of the housing 110, and has the other end fixed to the stepped part on the outer surface of the bearing member 170, such that the vibrating force may be transmitted to the housing 110.

The elastic member 180 may have an elastic force in the shaft direction. In this connection, the elastic member 180 may be a coil spring or a flat spring. However, the present invention is not limited thereto, but any component having an elastic force in the shaft direction may be used.

The shaft 130 may pass through the center in the shaft direction of the elastic member 180. This is to prevent vibration in the radial direction when vibration in the shaft direction is generated in the vibrating part.

One end of the elastic member 180 may be fitted into the guide parts 112b and 114b of the housing 110. Further, the other end of the elastic member 180 may be disposed so as to be supported by the bearing members 170. Alternatively, the bearing members 170 may be enclosed and the end may be supported by the vibrating part (magnetic part 140 or mass body 150).

Eventually, a vibrating device consisting of the magnetic part 140, the mass body 150 and a vibration case 160 may vibrate in the shaft direction with the ends of the vibrator is hung by the elastic member 180 in the housing 110.

The diameter of the elastic member 180 maybe smaller than the inner diameter of the case 112, and a gap may be formed between the elastic member 180 and the printed circuit board 190 to be described below.

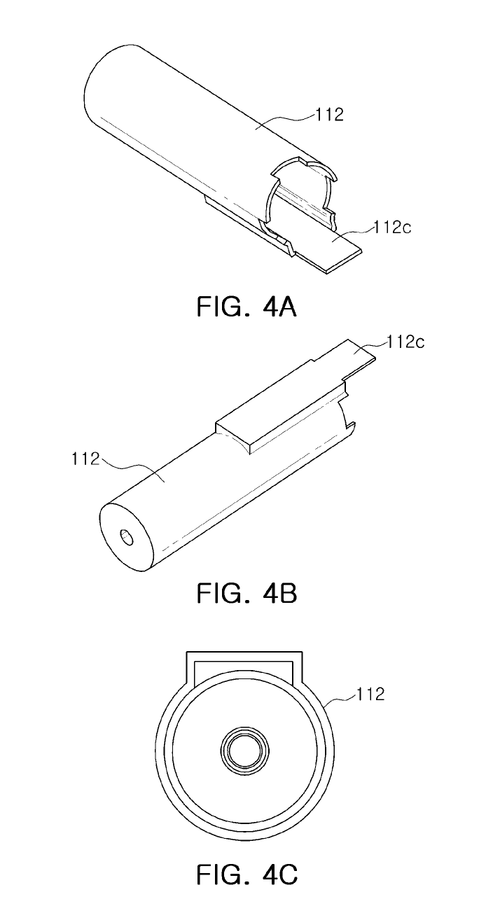

FIGS. 4A to 4C are perspective and front views of a housing of the vibrating device according to an embodiment of the present invention; FIG. 5 is a perspective view of the vibrating device according to the embodiment in which a case and a printed circuit board are coupled to each other; and FIG.

6 is a perspective view of the vibrating device according to the embodiment in which the case, a bracket and the printed circuit board are coupled to one another.

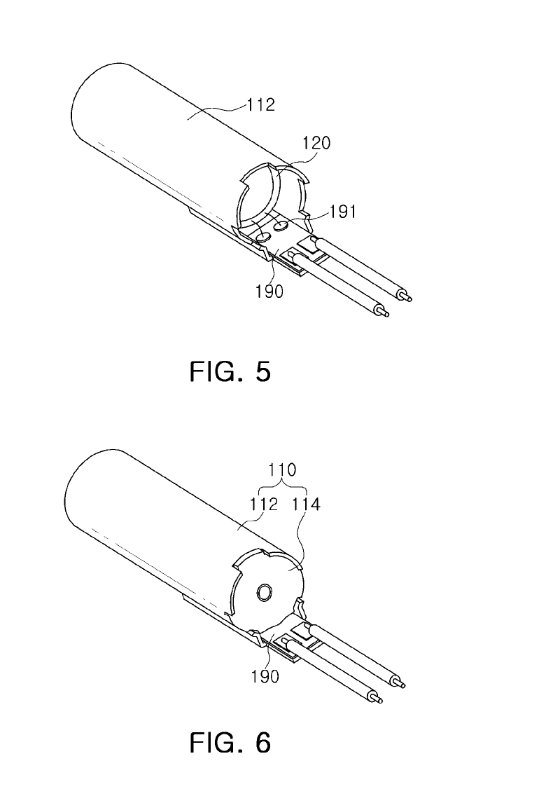

Referring to FIGS. 4 to 6, a case provided in the vibrating device according to the embodiment of the present invention will be described.

The case 112 may be formed in the longitudinal direction, have an internal space, and have an opening on one side.

At the opening on the one side of the case 112, a protrusion 112c may be provided protruding in the longitudinal direction of the case 112, and a bracket 114 may be coupled to the opening on the one side of the case 112 so that the internal space may be enclosed.

That is, the protrusion 112c may protrude beyond the bracket 114.

The case 112 may have a cylindrical shape, and parts of the external and internal surfaces of the case 112 may have a flat shape.

Specifically, the flat shape may extend in the longitudinal direction toward the opening on one side of the case 112 from a predetermined position of the case 112.

Here, the protrusion 112c may also have a flat shape, and may extend from the flat shape on the external and internal surfaces of the case 112.

The protrusion 112c, specifically the inner surface thereof, may couple with a printed circuit board 190.

Accordingly, the printed circuit board 190 may be provided on the inner surface of the housing 110 including the case 112 and the bracket 114, and one side of the printed circuit board 190 is disposed adjacently to one side of the coil 120.

The printed circuit board 190 may include an electrode pad 191 for transmitting an electrical signal having a specific frequency to the coil 120, and the electrode pad 191 may be electrically connected to a lead-out line of the coil 120.

That is, the electrode pad 19 and one end of the lead-out line of the coil 120 may be electrically connected by soldering.

The one side of the printed circuit board 190 and the one side of the coil 120 are closely disposed, and a gap is formed between the printed circuit board 190 and the elastic member 180, such that the lead-out line of the coil 120 is free from the interferences of other internal components even if the other internal components vibrate.

In other words, even when the vibrating device according to the embodiment of the present invention vibrates, and thus the vibrating part, the bearing members 170, and the elastic member 180 vibrate, they have no influence on the lead-out line of the coil 120.

Accordingly, a short circuit of the lead-out line of the coil 120 may be prevented.

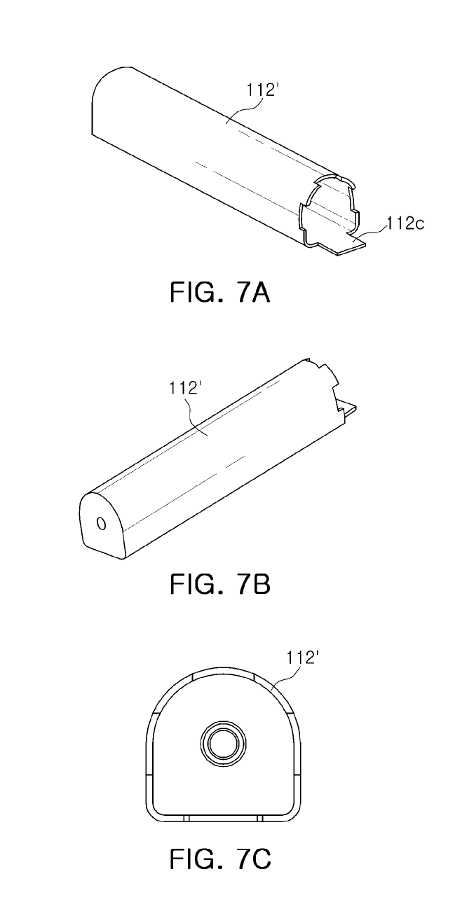

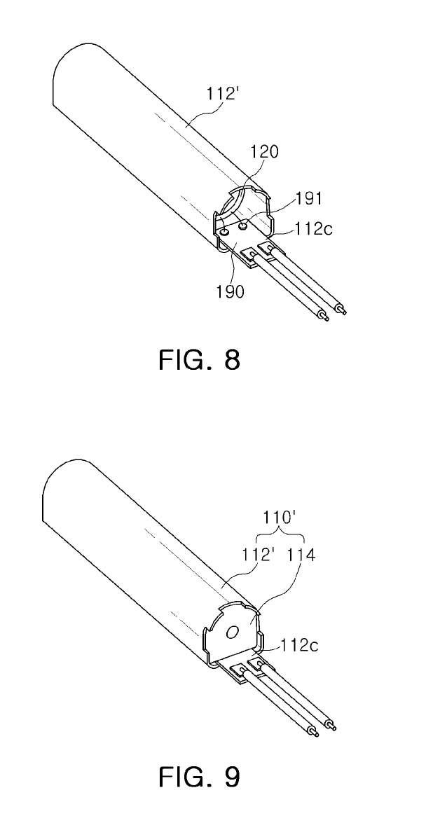

FIGS. 7A to 7C are perspective and front views of a housing of the vibrating device according to another embodiment of the present invention; FIG. 8 is a perspective view of the vibrating device according to the another embodiment in which a case and a printed circuit board are coupled to each other; and FIG. 9 is a perspective view of the vibrating device according to the another embodiment in which the case, a bracket and the printed circuit board are coupled to one another.

Referring to FIGS. 7 to 9, a case provided in the vibrating device according to the another embodiment of the present invention will be described.

The case 112′ may be formed in the longitudinal direction, have an internal space, and have an opening on one side.

At the opening on the one side of the case 112′, a protrusion 112c may be provided protruding in the longitudinal direction of the case 112′, and a bracket 114 may be coupled to the opening on the one side of the case 112′ so that the internal space may be enclosed.

That is, the protrusion 112c may protrude beyond the bracket 114.

The case 112′ may have at least partially flat surface, and have a cylindrical shape except for the flat surface.

Specifically, the case 112′ may have a half-cylindrical shape, one surface of which may be flat.

Here, the protrusion 112c may also have a flat shape, and may extend from the flat surface of the half-cylindrical case 112′.

In addition, the protrusion 112c may have a width smaller than that of one surface of the case 112′.

The protrusion 112c, specifically the inner surface thereof, may couple with a printed circuit board 190.

Accordingly, the printed circuit board 190 may be provided in the housing 110′ including the case 112′ and the bracket 114, and one side of the printed circuit board 190 is disposed adjacently to one side of the coil 120.

The printed circuit board 190 may include an electrode pad 191 for transmitting an electrical signal having a specific frequency to the coil 120, and the electrode pad 191 may be electrically connected to a lead-out line of the coil 120.

That is, the electrode pad 19 and one end of the lead-out line of the coil 120 may be electrically connected by soldering.

The one side of the printed circuit board 190 and the one side of the coil 120 are closely disposed, and a gap is formed between the printed circuit board 190 and the elastic member 180, such that the lead-out line of the coil 120 is free from the interferences of other internal components even if the other internal components vibrate.

In other words, even when the vibrating device according to the another embodiment of the present invention vibrates, and thus the vibrating part, the bearing members 170, and the elastic member 180 vibrates, they have no influence on the lead-out line of the coil 120.

Accordingly, a short circuit of the lead-out line of the coil 120 may be prevented.

Further, since one surface of the case 112′ is flat, the vibrating device according to the another embodiment may be stably fixed to an external electronic device.

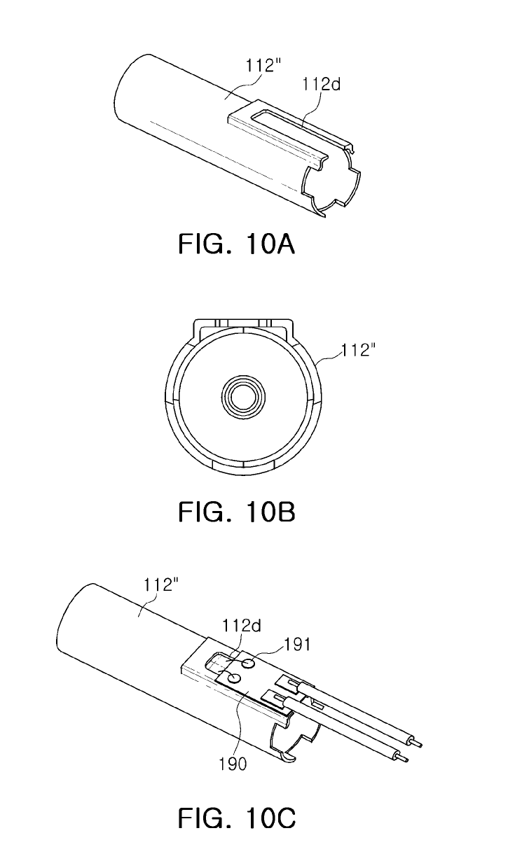

FIGS. 10A to 10C are perspective and front views of a housing of a vibrating device according to another embodiment of the present invention.

Referring to FIGS. 10A to 10C, a case provided in the vibrating device according to the present embodiment of the present invention will be described.

The case 112″ may have an opening on one side, and at least one surface of the case 112″ may have a flat shape.

A bracket 114 is coupled to the opening on one side of the case 112″, such that the internal space maybe enclosed.

The case 112″ may have at least partially flat surface, and have a cylindrical shape except for the flat surface.

Here, the case 112″ may include a hole 112d penetrating through one surface thereof.

That is, the hole 112d may be formed on a flat part of the outer surface of the case 112″, and the printed circuit board 190 may be attached to the outer surface of the case 112″ so as to cover the hole 112d.

Here, the printed circuit board 190 may cover only part of the hole 112 so that a part of the hole 112d remains opened.

Here, the coil 120 and the printed circuit board 190 may face each other with one surface of the case 112″ therebetween.

The printed circuit board 190 may include an electrode pad 191 for transmitting an electrical signal having a specific frequency to the coil 120, and the electrode pad 191 may be electrically connected to a lead-out line of the coil 120.

The lead-out line of the coil 120 may extend beyond the case 112″ through the hole 112d, and may be connected to the electrode pad 191 provided in the printed circuit board 190 so as to be powered.

That is, the electrode pad 19 and one end of the lead-out line of the coil 120 may be electrically connected by soldering.

Since the lead-out line of the coil 120 and the electrode pad 191 are connected outside the case 112″, even when the vibrating device according to the present embodiment vibrates, and thus the vibrating part, the bearing members 170, and the elastic member 180 vibrate, they have no influence on the lead-out line of the coil 120.

Accordingly, a short circuit of the lead-out line of the coil 120 may be prevented.

As set forth above, according to embodiments of the present invention, a housing and a vibrating device including the same can be provided in which the arrangements of components are improved so that the vibrating device can be smaller, which can stop as soon as a vibration condition is over, and which can prevent contact between the components and a coil therein in operation.

While the present invention has been shown and described in connection with the embodiments, it will be apparent to those skilled in the art that modifications and variations can be made without departing from the spirit and scope of the invention as defined by the appended claims.

What is claimed is:

1. A housing, comprising:
a case formed in a longitudinal direction, having an opening on one side, and having an internal space; and
a bracket coupled to the opening on the one side of the case,
wherein the case has a protrusion formed at the opening and protruding in the longitudinal direction of the case.

2. The housing of claim 1, wherein the case has a cylindrical shape, and wherein parts of external and internal surfaces of the case have a flat shape.

3. The housing of claim 2, wherein the flat shape extends toward the opening of the case in the longitudinal direction from a predetermined position of the case.

4. The housing of claim 2, wherein the protrusion is formed on flat parts of the external and internal surfaces of the case and extends therefrom.

5. The housing of claim 1, wherein the case has a half-cylindrical shape, and wherein one surface of the case has a flat shape.

6. The housing of claim 5, wherein the protrusion is formed on the one surface of the half-cylindrical case having the flat shape, and extends therefrom.

7. The housing of claim 6, a width of the protrusion is smaller than that of the one surface of the case.

8. A vibrating device, comprising:
the housing of claim 1;
a shaft provided in the internal space;
a frame into which the shaft is inserted;
a vibrating part coupled to an outer peripheral surface of the frame and having a magnetic part;
a bearing member supporting the frame so that the shaft and the frame are spaced apart from each other by a predetermined distance;
an elastic member provided at both ends of the vibrating part; and
a coil provided in the internal space and interacting with the magnetic part so as to vibrate the vibrating part.

9. The vibrating device of claim 8, wherein the coil is mounted on an inner surface of the case.

10. The vibrating device of claim 8, wherein the protrusion has a printed circuit board mounted on its inner surface, and wherein one side of the printed circuit board is disposed adjacently to one side of the coil.

11. The vibrating device of claim 10, wherein a lead-out line of the coil is electrically connected to the printed circuit board.

12. A housing, comprising:
a case formed in a longitudinal direction, having an opening on one side, and having an internal space; and
a bracket coupled to the opening on the one side of the case,
wherein the case has a hole penetrating through one surface thereof.

13. A vibrating device, comprising:
the housing of claim 12; and
a printed circuit board mounted on an outer surface of the case so as to cover at least part of the hole.

14. A vibrating device, comprising:
the housing of claim 12;
a shaft provided in the internal space;
a frame into which the shaft is inserted;
a vibrating part coupled to an outer peripheral surface of the frame and having a magnetic part;
a bearing member supporting the frame so that the shaft and the frame are spaced apart from each other by a predetermined distance;
an elastic member provided at both ends of the vibrating part; and
a coil provided in the internal space and interacting with the magnetic part so as to vibrate the vibrating part.

15. The vibrating device of claim 14, wherein a printed circuit board is mounted on an outer surface of the case so as to cover at least part of the hole, and wherein a lead-out line of the coil passes through the hole so as to be electrically connected to the printed circuit board.
